(19) United States
(12) Patent Application Publication
(10) Pub. No.: US 2022/0188935 A1
(43) Pub. Date: Jun. 16, 2022

(54) INSURANCE MANAGEMENT SYSTEM

(71) Applicant: Ford Global Technologies, LLC, Dearborn, MI (US)

(72) Inventors: Michael Robert Tinskey, Commerce, MI (US); Lawrence Coan, New Hudson, MI (US); Sheida Malekpour, Dearborn, MI (US); Nancy Chu-Meyers, Northville, MI (US); Jonathan Sayre Wood, Ames, IA (US); Gizelle Guerra, Canton, MI (US)

(21) Appl. No.: 17/117,660

(22) Filed: Dec. 10, 2020

(51) Int. Cl. G06Q 40/08; G07C 5/02; G07C 5/00

(52) U.S. Cl. CPC G06Q 40/08; G07C 5/008; G07C 5/02

(57) ABSTRACT

An insurance management system for a vehicle may include at least one advanced driver-assistance system (ADAS) system of a vehicle configured to provide an indication of activation of the ADAS system, a memory of a vehicle configured to maintain data relating to the vehicle and driver, and a processor of the vehicle configured to receive driver data indicative of driver behavior, the driving behavior indicative of activation of at least one ADAS feature, receive context data relating at least in part to the activation of the ADAS feature, and generate a risk value specific to the driver and the vehicle based at least in part on the context data and the activation of the at least one ADAS feature.

### TECHNICAL FIELD

This disclosure generally relates to insurance management systems.

### BACKGROUND

Automobile insurance premiums may be based on various factors relating to the driver. In addition, data collected from a vehicle may also be used to determine certain premiums. As autonomous vehicle features increase in today's vehicles, more and more data regarding the operation of the vehicle is available.

### SUMMARY

An insurance management system for a vehicle may include at least one advanced driver-assistance system (ADAS) system of a vehicle configured to provide an indication of activation of the ADAS system, a memory of a vehicle configured to maintain data relating to the vehicle and driver, and a processor of the vehicle configured to receive driver data indicative of driver behavior, the driving behavior indicative of activation of at least one ADAS feature, receive context data relating at least in part to the activation of the ADAS feature, and generate a risk value specific to the driver and the vehicle based at least in part on the context data and the activation of the at least one ADAS feature.

A method for generating a risk assessment value for a vehicle insurance management system, may include receiving driver data indicative of driver behavior, the driving behavior indicative of activation of at least one advanced driver-assistance system (ADAS) feature, receiving context data relating at least in part to the activation of the ADAS feature, and generating a risk value specific to the driver and the vehicle based at least in part on the context data and the activation of the at least one ADAS feature.

An insurance management system for a vehicle may include a memory of a vehicle configured to maintain data relating to the vehicle and driver, and a processor of the vehicle configured to receive driver data indicative of driver behavior, receive context data relating at least in part to the driver behavior, receive vehicle data relating to vehicle features and attributes, and generate a risk value specific to the driver and the vehicle based at least in part on the driver data, context data, and vehicle data.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example diagram including a vehicle configured to access telematics servers and facilitate an insurance management system;

FIG. 2 illustrates an example block diagram of the insurance management system; and

FIG. 3 illustrates an example block diagram of a driver category of the insurance management system;

FIG. 4 illustrates an example block diagram of a vehicle category of the insurance management system; and

FIG. 5 illustrates an example process of the insurance management system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Automobile insurance premiums are typically calculated based on certain factors relating to the vehicle and the driver of the vehicle. Vehicle data may include the vehicle purchase price, vehicle loss experience, and vehicle equipment. This may be determined based on the ten digit vehicle identification number (VIN). Driver data may include the driver's credit score and driving record. Driver data may also include driver provided responses regarding active safety features on the vehicle. However, relying on this data is not substantially accurate and can lead to misinformation. For example, customers may misinterpret, be unaware, or misrepresent certain vehicle features. The VIN may not provide enough details as to the vehicle equipment or vehicle feature breakdown. Further, using a person's credit score presents other accuracy and security related concerns, the least of which is that such a metric may not be indicative of a driver's driving behavior. Such accuracy issues may lead to inaccurate risk and loss predictions, which may in turn lead to insurance pricing that is not commensurate with risk.

Insurance providers may use usage based insurance (UBI) solutions by accessing a vehicle controller area network (CAN) bus via an onboard diagnostic (OBD) port. The OBD port may allow third parties to pull telematic data from the vehicle. This data may include certain vehicle conditions such as engine speed, vehicle speed, braking aggressiveness, etc. Insurance providers may offer discounts based on driver behavior indicated by the telematic data. However, often times such discounts are only available if the driver acquiesces to installing an OBD dongle device to capture the data. Drivers are historically reluctant to participate in these programs. Furthermore, while initial discounts may be offered, most are only available for a certain period of time or at policy renewal.

Disclosed herein is an insurance management system that utilizes built-level vehicle feature data, high resolution driver behavior data, and an understanding of the use of certain features, such as advanced driver assistance systems or Advanced driver-assistance systems (ADAS), impact loss experience to create an overall risk score for each customer. By compiling certain available data, a more accurate assessment of risk can be determined and used for insurance pricing purposes. This results in a more comprehensive and individualized approach to risk assessment that could not otherwise be done with conventional underwriting.

Thus, the system herein uses data made available by various sensor, telematics systems, etc., to determine a risk associated with a driver of a specific vehicle. Specifically, a driver score, vehicle score, and context score are taken into account in order to provide a more accurate and complete risk analysis for insurance providers.

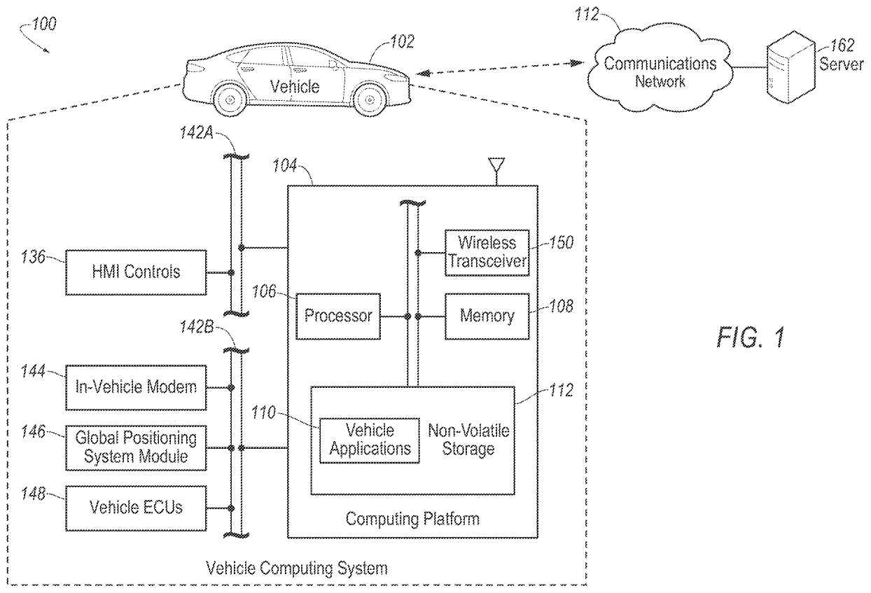

FIG. 1 illustrates an example system 100 including a vehicle 102 configured to access telematics servers. The vehicle 102 may include various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, MI. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable storage medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. The computing platform 104 may be further configured to communicate with other components of the vehicle 102 via one or more in-vehicle networks 142. The in-vehicle networks 142 may include one or more of the controller area network (CAN), an Ethernet network, and a media-oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 (or global navigation satellite system (GNSS) configured to provide current vehicle 102 location and heading information, and various vehicle electronic control units (ECUs) 148 configured to incorporate with the computing platform 104. As some non-limiting possibilities, the vehicle ECUs 148 may include a powertrain control module (PCM) configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

The ECUs 148 may also include other systems such advanced driver-assistance systems (ADASs), including remote detection systems such as BLIS, light detection and ranging (LIDAR) systems, other acceleration and sonar sensors, etc. These systems, and the systems described herein may be supplied to OEMs by third-party suppliers.

The ECUs 148 may communicate with the computing platform 104 over the in-vehicle network 142. In other examples, the computing platform 104 may be connected to more or fewer in-vehicle networks 142. Additionally or alternately, one or more controls, such as human machine interface (HMI) controls, etc., or other components may be connected to the computing platform 104 via different in-vehicle networks 142 than shown, or directly without connection to the in-vehicle network 142.

The communications network 156 may provide communications services, such as packet-switched network services (e.g., Internet access, VoIP communication services, vehicle to vehicle, over the air, etc.), to devices connected to the communications network 156. An example of a communications network 156 may include a cellular telephone network, other networks that facilitates wireless communication. The ECUs 148 such as the BLISS, LIDAR, etc., may send DTCs to the server via the communications network 156.

A server 162 may be external or internal to the vehicle or another structure. The server 162 may also be a cloud based server. The server 162 may include multiple devices or processors, as well as include storage mediums, applications, transceivers, etc. The server 162 may include or be in communication with a DTC database 164. This database 164 may maintain data relating to DTCs received from the vehicle 102 over the communications network 156. This is described in greater detail herein. The server 162 may generate a smart contract resulting from the DTCs received from the vehicle 102.

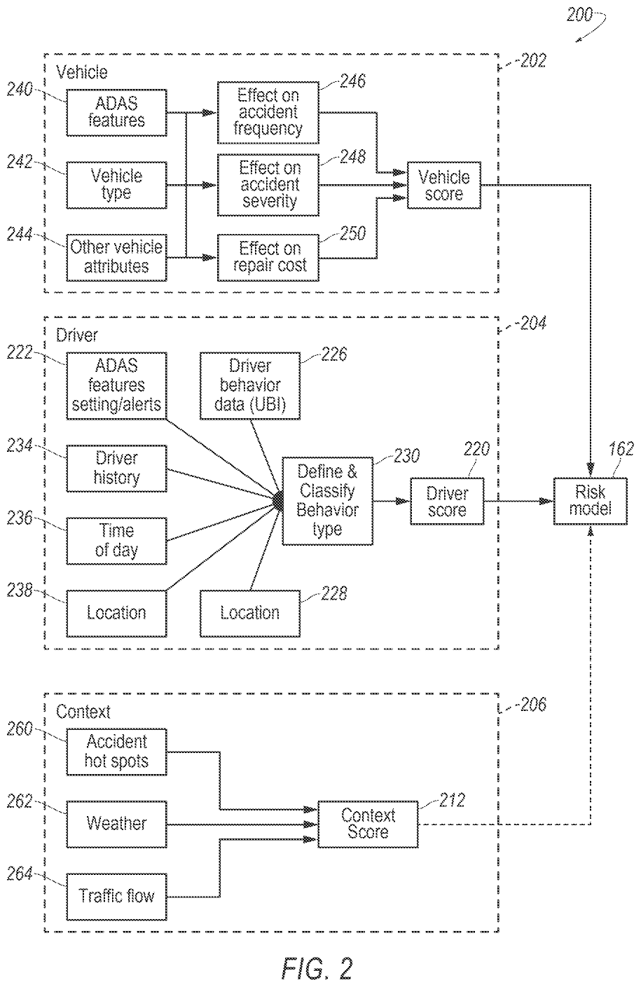

The processor 106 and one or more processors including in the server 162 may be configured to perform instructions, commands and other routines in support of the processes described herein. For instance, the server 162 and/or processor 106 may be configured to determine a risk assessment score for an insurance management system as described in FIGS. 2-5. Such instructions and other data may be maintained in a non-volatile manner using a variety of types of computer-readable storage mediums such as a database or other memories, including memory 108 and a memory or memories included on the server 162. The mediums (also referred to as a processor-readable medium or storage) includes any non-transitory medium (e.g., a tangible medium) that participates in providing instructions or other data that may be read by the processor of the server. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. While the server 162 and the computing platform are described herein as each carrying out specific processes and instructions, each may carry out processes described with the other.

FIG. 2 illustrates an example block diagram of the insurance management system 200. The insurance management system 200 may be located in the server 162, or on the vehicle 102. The system 200 may also be arranged in the cloud, at an insurance provider, etc. The system 200 may include sub-categories, each used to provide data and analysis for the risk assessment value 220. The sub-categories may each provide a score relating to that category. In the examples shown in FIG. 2, the system 200 includes a vehicle category 202 providing a vehicle score 208, a driver category 204 providing a driver score 210, and a context category 206 providing a context score 212. Each of these categories may be combined, weighted, averaged, etc., to achieve the risk assessment value. As explained, the risk assessment value may be used to determined insurance premiums, ether as part of an OEM insurance policy, or for used by an insurance provider. The risk assessment value may also be of use to third party data aggregators.

The driver category 204 may include data collected relating specifically the driver. This may be an individual, owner of the vehicle, etc. The driver data may include data collected from UBI packages on the in-vehicle modem 144 shown in FIG. 1. This driver data may be derived from the telematics data. The driver data may also include driver demographic data. The driver data may be used to generate a driver score for the individual driver, as well as access riskiness and highlight improvement opportunities in general.

The driver category 204 may receive ADAS driver data 222 via the vehicle modem 144. The ADAS driver data 222 may include data from vehicle systems that typically assist drivers with parking and driving. Some of these systems include autonomous features, and many employ the user of sensors and other data to perform various tasks such as parallel parking, and provide data to the driver, such as back up alerts, etc. The ADAS driver data 222 may include data indicative of an activation of these systems, use of these systems, etc. In one example, the ADAS driver data 222 may indicate whether the driver has a blind spot detection system (BLISS) activated. Use of this system may be considered to aid the user in avoiding collisions, and thus increase safety. Other ADAS systems may include adaptive cruise control (ACC), back up cameras, a collision avoidance system (e.g., pre-crash systems), automatic parking systems, anti-lock brakes, heads-up-display (HUD), driver alertness detection, forward collision warning (FCW), stability controls, lane departure warnings, tire pressure monitoring (TPS), among others.

The ADAS driver data 222 may indicate both manual activation of these systems, e.g., the driver selects to activate the use of the feature, as well as automatic activation of these systems, e.g., once activated, either by the driver or as a default, the vehicle uses the feature (e.g., emergency braking, forward collision, etc.). This ADAS driver data 222 may be used to discern various driver behaviors.

Driver behavior data 226 may also be used to determine the driver score 210. Driver behavior data 226 may include usage based information such as mileage, speed, time of day, etc. This driver behavior data 226 may be acquired via a dongle or other telematic data. In other examples, the driver's mobile device may also provide the behavior data 226.

Demographic data 228 may include data personal to the driver such as age, race, ethnicity, gender, marital status, income, credit score, employment, occupation, etc. This may be data that is provided by the driver at the time of registering the vehicle, purchasing the vehicle, applying for insurance, quotes, etc. This demographic data 228 may be weighed against other statistical data for similarly situated individuals to also be a factor in determining the driver score 210.

Driver history data 234 may include data related to the driver's driving history such as traffic infractions, accident history, arrests, etc. The driver data history 234 may also include an experience level of the driver, past insurance claims, etc.

Time of day data 236 may be the time of day at which the driver typically drives. This may overlap with the behavior data 226. This may be attributable to the driver score in that certain times of driving (e.g., during high traffic times), may be riskier than others.

Location data 238 may be the location or area in which the driver drives. This may be acquired via the telematics data from the GPS system 146 or the driver's mobile device. The location data 236 may be associated with the time of day data 236, as well as the ADAS data 222.

The driver data may be combined, weighed, and allocated at the classification model 230. The classification model 230 may combine data such as when and if emergency braking or forward collision warning features are activated, driver behavior data from UBI packages, to give a detailed synopsis of how the driver is driving. The classification model 230 may also classify how drivers are using ADAS features on the road, classify distracted drivers, and be used to generate additional rules for creating alerts or notifications for the driver. Due to access to telematics and UBI data, the system 200 can classify the driver in a more contextual basis. The driver data may provide the driver score based on the classification model 230.

The vehicle category 202 may include data collected relating specifically to the vehicle 102. This may include vehicle features, accident history of the specific vehicle, general information about the vehicle make and model generally, etc. Repair, part, and maintenance costs may also be included in the vehicle data. This information may be combined to generate the vehicle score 208.

Specifically, the vehicle data may include ADAS vehicle data 240. This ADAS vehicle data 240 may be similar to the ADAS data 222 included in the driver category. However, unlike the ADAS driver data 222, the ADAS vehicle data 240 is specific to the vehicle 102 and not necessarily the activation of the ADAS features. It may be assumed that vehicles with more ADAS features may be safer, easier to drive, more reliable, etc., than those vehicles without as many ADAS features. Further, some ADAS features may have a greater effect on safety, collision avoidance, etc. A front collision detection system may be more important for risk purposes than a parallel park assist system.

Vehicle type data 242 may include data relating to the type of vehicle, such as a truck, sedan, SUV, etc. The type of vehicle may also be attributable to certain costs, such as accident severity.

Vehicle attribute data 244 may include additional vehicle attributes, equipment, and features. For example, the vehicle attribute data 244 may include whether the vehicle includes a hitch for towing, or a tow bar, grill grates, roof racks, etc. These items may be after market add-ons that may affect repair costs, vehicle capabilities, etc. Vehicle attributes include the make/model/year, trim information, any structural characteristics that may affect loss severity (e.g., steel or aluminum body, body-on frame or uni-body, etc.).

The vehicle data, including the ADAS vehicle data 240, vehicle type data 242, and vehicle attribute data 244, may be combined to generate specific effects. These effects may include an accident frequency affect 246, accident severity effect 248, and cost effect 250. The vehicle data may be aggregated to determine each of these effects. For example, certain ADAS features in an SUV may lower the accident frequency effect 246. However, the same vehicle may have an increased repair cost effect due to the additional sensors required to maintain the ADAS features, as well as the general size of the vehicle. Accident severity may take into account the specific vehicle, persons within the vehicle, as well as the potential damage caused to other vehicles.

The effects may be based at least in part on police reported crash data, repair data, both from dealerships and authorized body shops, as well as other third party sources that collect loss experience data. The efficacy of the ADAS features and other vehicle equipment may also be taking into consideration when determining the effects. The effects are then combined to determine a vehicle score 208 for the vehicle configuration.

In addition to this, analytic data may be available that contains vehicle setting configuration data. This data may indicate which features are turned on or off and various setting levels, where applicable. This data may aid in showing how ADAS systems are used by customers on an average, and therefor generalize certain population's or demographic's use of the features. This type of data may be used in each of the driver and vehicle categories to increase risk accuracy by quantifying the effects of the ADAS features.

The context category 206 may include data that relates to the context of other data points, such as weather conditions, traffic patterns, intersections, etc. The context category 206 includes hot spot data 260, weather data 262, and traffic data 264.

The hot spot data 260 may include data that indicates certain areas may be identified as traffic or accident “hot spots.” These hot spots may be areas or intersections where accidents typically occur. These hot spots may be defined both by location and time of day, as well as during certain weather conditions. For example, a mount pass may see more accidents during early snow fall, and intersection may see more accidents during rush hour. Having knowledge of these locations can increase the accuracy of the risk assessment in several ways. First, the location, time of day, and weather may add context to driver behavior, such as harsh braking, activation of front collision sensors, etc. Second, the frequency that a driver is driving at the location may indicate certain risks and costs for the driver and/or vehicle.

In the first example, the context score being used to mitigate less than desirable driver behavior. A driver who is in an area known as a hot spot under certain conditions (e.g., time of day or weather), may harshly brake in this area. This may be indicated via data from the UBI package in the telematics data. The context category 206 may allow the system 200 to derive a more accurate risk assessment by attributing the driver's harsh braking to the traffic situation at the hot spot. Thus, the driver may not be penalized for this driving behavior when it comes to his or her insurance premium.

The vehicle score 205, driver score 210, and context score 212 all may factor into the overall risk assessment value 270. This value may be a collective score that may be used by OEMs or insurance providers to adjust or generate insurance premiums for drivers of specific vehicles. The system 200 avoids the need for an OBD dongle, and is more advanced than typical UBI systems. The system 200 uses ADAS feature usage and settings to affect a vehicle score, additionally, vehicle and driver scores are combined into the overall risk assessment value 270. The system 200 uses a wider range of data and incorporates and relates the data in a contextual manner in order to more accurately assess driver and vehicle risks. Historical driver data may also be used to encourage safe driving and provide discounts.

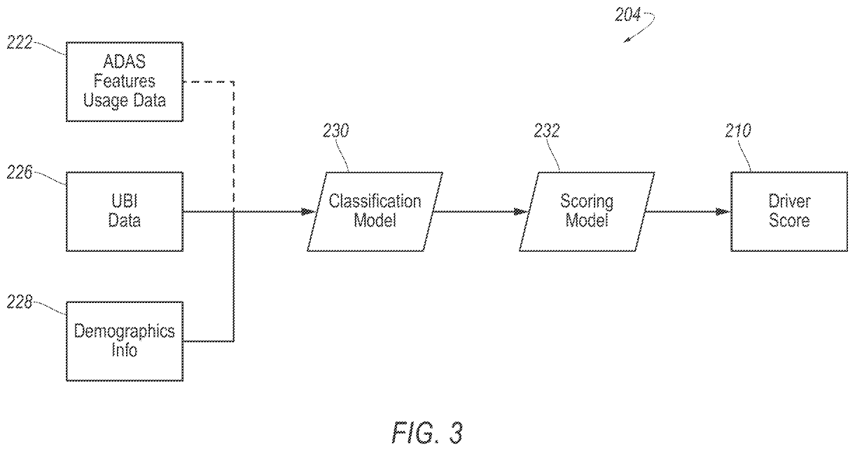

Referring to FIG. 3, further details of the driver category 204 are illustrated. As explained with respect to FIG. 2, the driver category 204 includes various data sets that are compiled to generate a driver score 210. ADAS data 222, UBI or driver behavior data 226, and demographic data 228 are some of the key data sets used by the classification model 230 to generate the drive score. 210. A scoring model 232 may apply the classification from the classification model 230. The driver score is based on classification of the driver's behaviors such as harsh breaking, lane drifting, etc. These behaviors may be categorized and aggregated with weights and/or values assigned to those categories. Learning models may be implemented to achieve such categorical classifications. Additionally or alternatively, look up tables may be used and include score values assigned to specific categories. These tables may map, for example, behaviors classified as “distracted driving” to a numerical value to be used in computing the driver score. Statistical modeling techniques may also be used to derive the driver score, where estimates on a likelihood of loss and estimate cost of repair based on the vehicle features may be combined with accident and insurance claims data.

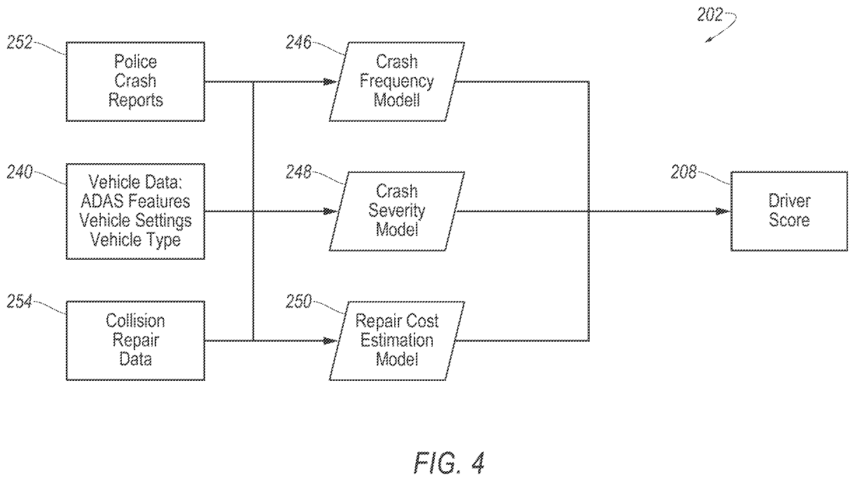

Referring to FIG. 4, further details of the vehicle category 204 are illustrated, As explained with respect to FIG. 2, the vehicle category 202 includes various data sets and effects of those data sets to generate the vehicle score 208. ADAS vehicle data 240, vehicle type data 242, and vehicle attribute data 244 are some of the key data sets used to generate the drive score. In addition to these data sets, police crash reports 252 may also be used to determine accident frequency, number of vehicles in the accident, time of day, weather conditions, etc. Police reports 252 may be region specific to the region in which the vehicle 102 predominantly resides. Police reports 252 may also be general collective data specific to that vehicle.

Further, collision repair data 254 may also be used in the vehicle category 202. The collision repair data 254 may include data associated with costs of repairs, length of repairs, totality rates, etc. The collision repair data 254 may be provided by dealerships, repair shops, etc. Additional data for general wear and tear on a vehicle may also be included in the vehicle data, including warranty claims, recall information, and the like.

The effects, including the accident frequency affect 246, accident severity effect 248, and cost effect 250, as described above with respect to FIG. 2, may then be combined to generate the vehicle score 208.

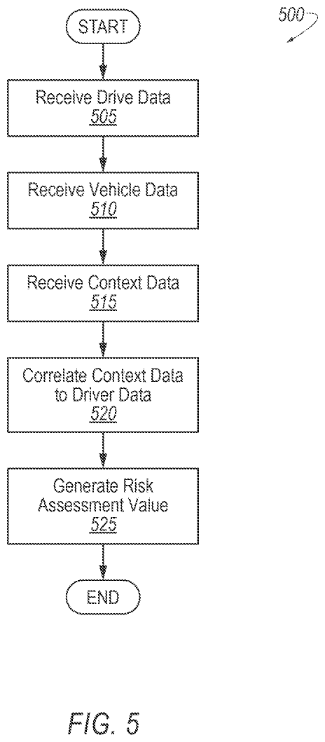

FIG. 5 illustrates an example process 500 for the system of FIG. 2. The process 500 starts at block 505 where the processor 106 receives driver data. As explained above, the driver data may include ADAS driver data 222, driver behavior data 226, demographic data 228, driver history data 234, time of day data 236, and location data 238. The driver data may be derived from the vehicle telematics, UBI data, as well as driver inputted data from a third party such as government agencies, insurance providers, OEMs, etc. The driver data may indicate data specific the driver, as well as generalized data about other drivers within a similar demographic.

At block 510, the processor 106 may receive vehicle data. As explained above, the vehicle data may include ADAS vehicle data 240, vehicle type data 242, and vehicle attribute data 244. Other data may also be included in vehicle data, such as collision repair data 254 and police crash reports 252. That is, the vehicle data relates specifically to the vehicle 102. This may include vehicle features, accident history of the specific vehicle, general information about the vehicle make and model generally, etc. Repair, part, and maintenance costs may also be included in the vehicle data.

At block 515, the processor 106 may receive context data. The context data includes data that relates to the context of other data points, such as weather conditions, traffic patterns, intersections, etc. For example, and as described herein, the context data includes hot spot data 260, weather data 262, and traffic data 264.

At block 520, the processor 106 may correlate the context data to the received driver data. For example, the context data may be used to mitigate less than desirable driver behavior, such as harsh braking, activation of certain ADAS features, etc. In the example discussed herein, ADAS driver data 222 may indicate that a certain driver has a tendency to harshly brake in a certain area. The context data may indicate that this area is a hot spot due to the traffic levels at a certain time of day. The context data may be correlated to certain driver data. This allows the driver data to be supplemented by adding context to the data. For example, severe weather may have an impact on the efficacy of ADAS features that rely on sensors and cameras. The context data may contain a separate determination from the vehicle and driver scores that may mitigate any driving behavior or lack of activation of the ADAS features when combined with the vehicle and driver scores.

At block 525, the processor 106 may generate the risk assessment value based on, at least in part, on the drive data, vehicle data, and context data. The score may indicate a risk level associated with the driver and vehicle based on various data inputs including telematic data, UBI data, user provider data, etc. The risk value may include an average, or weighted average, of the driver score, vehicle score, and context score. Additionally, the driver score may be mitigated or discounted by context data, as explained above. A driver who is in an area known as a hot spot under certain conditions (e.g., time of day or weather), may harshly brake in this area. This may be indicated via data from the UBI package in the telematics data. The context category 206 may allow the system 200 to derive a more accurate risk assessment by attributing the driver's harsh braking to the traffic situation at the hot spot. Thus, the driver may not be penalized for this driving behavior when it comes to his or her insurance premium.

While the process 500 is described as being done by processor 106, other processors, controllers, and servers may also conduct the process 500, as well as other processes described herein. Data may be stored on the vehicle or remote of the vehicle and may be received from the server 162, a communications network 112, cloud based storage systems, etc.

Thus, disclosed herein is a, insurance management system that provides a risk assessment value based on a vehicle score, driver score, and context score. This value may be a collective score that may be used by OEMs or insurance providers to adjust or generate insurance premiums for drivers of specific vehicles. The system avoids the need for an OBD dongle, and is more advanced than typical UBI systems. The system uses ADAS feature usage and settings to affect a vehicle score, additionally, vehicle and driver scores are combined into the overall risk assessment value 270. The system uses a wider range of data and incorporates and relates the data in a contextual manner in order to more accurately assess driver and vehicle risks. Historical driver data may also be used to encourage safe driving and provide discounts.

Computing devices described herein, such as the telematics controller 180, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description, but with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An insurance management system for a vehicle, comprising:
at least one advanced driver-assistance system (ADAS) system of a vehicle configured to provide an indication of activation of the ADAS system;
a memory of a vehicle configured to maintain data relating to the vehicle and driver;
at least one sensor configured to provide context data indicative of driving conditions, and
a processor of the vehicle configured to
receive driver data indicative of driver behavior, the driving behavior indicative of activation of at least one ADAS feature;
receive the context data relating at least in part to the activation of the ADAS feature; and
generate a risk value specific to the driver and the vehicle based at least in part on the context data and the activation of the at least one ADAS feature, wherein the risk value is lowered in response to the context data relating to the activation of the ADAS feature.

2. (canceled)

3. The system of claim 1, wherein the processor is further configured to receive vehicle data specific to vehicle attributes and features and wherein the risk value is generated, at least in part, based on the vehicle data.

4. The system of claim 3, wherein the vehicle data includes vehicle ADAS data indicative of ADAS features available on the vehicle.

5. The system of claim 1, wherein the context data includes at least one location hot spot, and wherein the risk value is generated based at least in part on the hot spot in response to the hot spot corresponding to at least one driver behavior.

6. The system of claim 1, wherein the driver behavior includes an indication of harsh braking.

7. The system of claim 1, wherein the driver data includes usage based data.

8. The system of claim 1, wherein the driver data includes driver provided demographic data.

9. A method for generating a risk assessment value for a vehicle insurance management system, comprising:
receiving driver data indicative of driver behavior, the driving behavior indicative of activation of at least one advanced driver-assistance system (ADAS) feature;
receiving context data relating at least in part to the activation of the ADAS feature; and
generating a risk value specific to the driver and the vehicle based at least in part on the context data and the activation of the at least one ADAS feature, wherein the risk value is lowered in response to the context data relating to the activation of the ADAS feature.

10. (canceled)

11. The method of claim 9, further comprising receiving vehicle data specific to vehicle attributes and features, wherein the risk value is generated, at least in part, based on the vehicle data.

12. The method of claim 11, wherein the vehicle data includes vehicle ADAS data indicative of ADAS features available on the vehicle.

13. The method of claim 9, wherein the context data includes at least one location hot spot, and wherein the risk value is generated based at least in part on the hot spot in response to the hot spot corresponding to at least one driver behavior.

14. The method of claim 9, wherein the driver behavior includes an indication of harsh braking.

15. The method of claim 9, wherein the driver data includes usage based data.

16. The method of claim 9, wherein the driver data includes driver provided demographic data.

17. An insurance management system for a vehicle, comprising:
a memory of a vehicle configured to maintain data relating to the vehicle and driver; and
at least one sensor configured to provide context data indicative of driving conditions,
a processor of the vehicle configured to
receive driver data indicative of driver behavior;
receive context data relating at least in part to the driver behavior;
receive vehicle data relating to vehicle features and attributes, wherein the driver data includes activation of at least one advanced driver-assistance system (ADAS) feature of the vehicle, wherein the context data correlates to the activation of the at least one ADAS feature, and wherein the vehicle data includes vehicle ADAS data indicative of ADAS features available on the vehicle; and
generate a risk value specific to the driver and the vehicle based at least in part on the driver data, context data, and vehicle data,—wherein the risk value is lowered in response to the context data relating to the activation of the ADAS feature.

18. (canceled)

19. (canceled)

20. The system of claim 17, wherein the context data includes at least one location hot spot, and wherein the risk value is generated based at least in part on the hot spot in response to the hot spot corresponding to at least one driver behavior.
